(19) United States
(12) Patent Application Publication
(10) Pub. No.: US 2004/0026541 A1
(43) Pub. Date: Feb. 12, 2004

(54) Fuel injection valve

(76) Inventors: Thomas Sebastian, Stuttgart (DE); Jens Pohlmann, Schwieberdingen (DE); Guido Pilgram, Schwieberdingen (DE)

Correspondence Address: KENYON & KENYON, ONE BROADWAY, NEW YORK, NY, 10004, US

(21) Appl. No.: 10/333,532

(22) PCT Filed: May 10, 2002
(86) PCT No.: PCT/DE02/01691

(30) Foreign Application Priority Data
May 21, 2001 (DE) 101247435

(51) Int. Cl. F02M 61/00

(52) U.S. Cl. 239/585.5; 239/585.1; 239/585.4; 239/533.12

(57) ABSTRACT

A fuel injector (1) for the direct injection of fuel into the combustion chamber of an internal combustion engine, having a valve needle (3), which is in operative connection with a valve-closure member (4), which forms a sealing seat with a valve-seat surface (6); and an armature (20), which is positioned on the valve needle (3) in an axially movable manner und cooperates with a magnetic coil (10). The armature (20) includes an armature casing (34) and an armature-stop sleeve (35), the armature-stop sleeve (35) being inserted into an inner opening (37) of the armature casing (34) in a form-fitting manner.

### BACKGROUND INFORMATION

European Patent No. 0 683 862 describes an electromagnetically operable fuel injector whose armature is characterized in that the armature-stop face facing the inner pole is slightly wedge-shaped so as to minimize or completely eliminate the hydraulic damping during opening the fuel injector as well as the hydraulic adhesion force after switching off the current that energizes the solenoid coil. In addition, owing to suitable measures such as vapor deposition and nitration, the stop face of the armature is wear-resistant, so that the stop face has the same size during the entire service life of the fuel injector, and the functioning of the fuel injector is not impaired.

Disadvantageous in the fuel injector known from the aforementioned printed publication, in particular, is that, although the surface of the armature making impact with the inner pole of the magnetic circuit is, in fact, minimized and additionally hardened, turbulences and flows occur during the displacement of the fuel when the armature is attracted, due to the design of the armature stop face. These not only have a negative influence on the opening times of the fuel injector, but also lead to damage of the armature and the armature-stop face of the inner pole, as a result of hydro-dynamic effects.

### SUMMARY OF THE INVENTION

The fuel injector according to the present invention has the advantage over the related art that the function of the armature stop is assumed by an armature-stop sleeve, which is inserted into, and connected to, an outer armature casing, so that the main energy of the armature impact is absorbed by the armature stop sleeve and not by the armature casing. The armature casing and the armature-stop face of the inner pole, thus, are largely protected from damage.

It is especially advantageous in this context that, in contrast to the armature casing, the armature-stop sleeve is not made of magnetically soft material, which has only limited use in continuous operation, but, for example, of a robust, hardened metal or a metal alloy, or a metal-plastic combination.

It is also advantageous that the armature-stop sleeve is simple to produce by turning (machine-cutting) or deep-drawing, and is able to be joined to the armature casing by compression molding or welding.

A drainage device, which includes a drainage opening and a bore in the armature-stop sleeve, advantageously provides for a correct, long-lasting seat of the damping element, which is positioned on the discharge side of the armature-stop sleeve.

### BRIEF DESCRIPTION OF THE DRAWINGS

FIG. 1 shows a schematic section through an exemplary embodiment of a fuel injector according to the present invention.

FIG. 2A shows a schematic view of the armature of the first exemplary embodiment of the fuel injector shown in FIG. 1, designed according to the present invention, in area IIC in FIG. 1.

FIG. 2B shows a schematic cross section through the armature of the fuel injector, designed according to the present invention, along line IIB-IIB in FIG. 2A.

FIG. 2C shows a schematic longitudinal section through the armature of the fuel injector, designed according to the present invention, in area IIC in FIG. 1.

### DETAILED DESCRIPTION

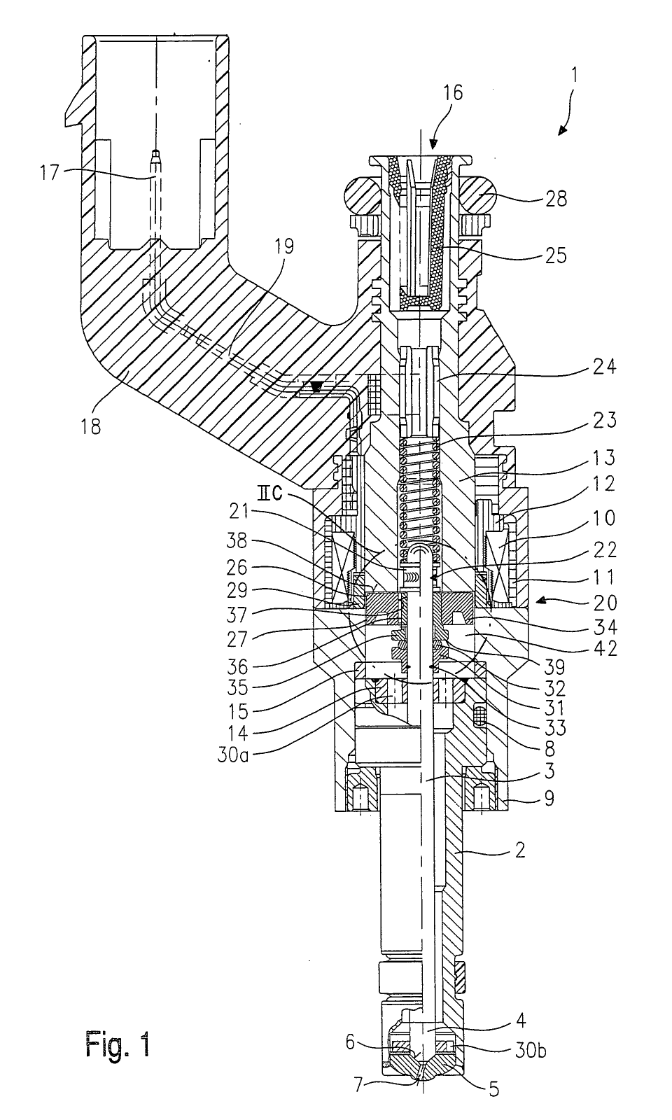

A fuel injector 1, as shown in FIG. 1, is designed in the form of a fuel injector 1 for fuel-injection systems of mixture-compressing internal combustion engines having externally supplied ignition. Fuel injector 1 is suitable, in particular, for the direct injection of fuel into a combustion chamber (not shown) of an internal combustion engine.

Fuel injector 1 is made up of a nozzle body 2 in which a valve needle 3 is positioned.

Valve needle 3 is in operative connection with a valve-closure member 4, which cooperates with a valve-seat surface 6, located on a valve-seat member 5, to form a sealing seat. In the exemplary embodiment, fuel injector 1 is an inwardly opening fuel injector 1, which has at least one spray-discharge orifice 7. Seal 8 seals nozzle body 2 from an outer pole 9 of a magnetic coil 10. Magnetic coil 10 is encapsulated in a coil housing 11 and wound on a coil brace 12, which rests against an inner pole 13 of magnetic coil 10. Inner pole 13 and outer pole 9 are separated from each other by a constriction 26 and interconnected by a non-ferromagnetic connecting part 29. Magnetic coil 10 is energized via a line 19 by an electric current, which may be supplied via an electrical plug contact 17. A plastic coating 18, which may be extruded onto inner pole 13, encloses plug contact 17.

Valve needle 3 is guided in a valve-needle guide 14, which is disk-shaped. A paired adjustment disk 15 adjusts the (valve) lift. On the other side of adjustment disk 15 is an armature 20. It is connected by force-locking to valve needle 3 via a flange 21, and valve needle 3 is connected to flange 21 by a welded seam 22. A restoring spring 23, which, in the present design of fuel injector 1, is prestressed by a sleeve 24, is braced against flange 21.

According to the present invention, armature 20 of fuel injector 1 is designed in two pieces. An outer armature casing 34 is made of a magnetically soft material, which has the advantage of high magnetic flow. However, magnetically soft materials have the disadvantage of insufficient resistance to mechanical wear, so that malfunctions occur over time by the operation of fuel injector 1, for instance, because of a changed armature lift. The service life of a magnetically soft armature 20, thus, is limited. In order to compensate for this, armature 20 is provided with an armature-stop sleeve 35, which is situated in an opening 37 of armature casing 34. Thus, armature-stop sleeve 35, in addition to the function of guiding the armature on the valve needle, also assumes the through-feeding of the fuel via at least one beveled surface section 36, and the fixation of the armature stops at first flange 21, which, on the inflow side of armature 20, is joined to valve needle 3 by a welding seam 22, and at a second flange 31, which is positioned on the discharge side of armature 20 and is likewise connected to valve needle 3 via a welding seam 33. To damp valve-needle bounce, a damping element 32 is additionally provided between second flange 31 and armature-stop sleeve 35. As in the present exemplary embodiment, it may be designed as an o-ring 32, but may also be designed in the form of a membrane.

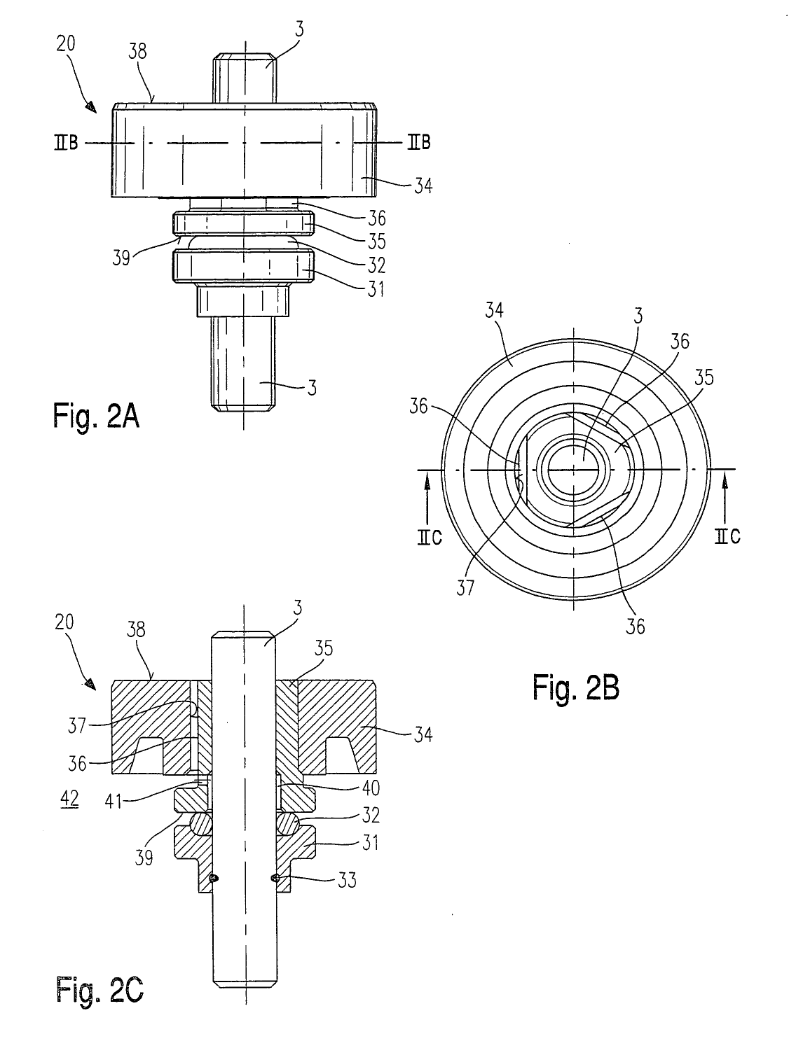

A detailed representation and description of the measures according to the present invention may be inferred from the description in connection with FIGS. 2A through 2C.

Fuel channels 30a and 30b run in valve-needle guide 14 and in valve-seat member 5. The fuel is supplied via a central fuel feed 16 and filtered by a filter element 25. Seal 28 seals fuel injector 1 from a fuel line (not shown further).

In the rest state of fuel injector 1, armature 20 is acted upon by restoring spring 23 in a direction opposite to its lift direction, in such a way that valve-closure member 4 is sealingly held against valve seat 6. When magnetic coil 10 is excited, it generates a magnetic field which moves armature 20 in the lift direction, counter to the spring force of restoring spring 23, the lift being defined by a working gap 27 occurring in the rest position between inner pole 12 and armature 20. Flange 21, which is welded to valve needle 3, is taken along by armature 20, in the lift direction as well. Valve-closure member 4, being connected to valve needle 3, lifts off from valve seat surface 6, and the fuel is spray-discharged through spray-discharge orifices 7.

When the coil current is switched off, after sufficient decay of the magnetic field, armature 20 falls away from inner pole 13 due to the pressure of return spring 23, so that flange 21, being connected to valve needle 3, moves in a direction counter to the lift. Valve needle 3 is thereby moved in the same direction, whereby valve-closure member 4 sets down on valve seat surface 6, and fuel injector 1 is closed.

FIG. 2A shows an overall non-sectional representation of the two-piece armature 20 with second flange 31 and damping element 32 on valve needle 3.

Identical parts are provided with the same reference numerals in all of the figures.

FIG. 2A clearly shows the pre-assembled overall component, which is inserted into housing 2 of fuel injector 1. First flange 21, not shown in FIG. 2A, is slid over valve needle 3 and welded therto. Two-piece armature 20, made up of armature casing 34 and armature-stop sleeve 35, is likewise slid over valve needle 3. Then, damping element 32, designed as an o-ring in the present specific embodiment, is slid over valve needle 3, either together with second flange 32 or separately. Finally, second flange 32 is also welded to valve needle 3 at a predefined distance that corresponds to the desired lift of valve needle 3.

Restoring spring 23 is supported on first flange 21 (not shown in FIG. 2A), which abuts against armature-stop sleeve 35, which terminates flush with an inflow-side end face 38 of armature casing 34. A discharge-side end 39 of armature-stop sleeve 35 is supported at damping element 32, which is prestressed and rests on second flange 31. Thus, armature casing 34, during operation of fuel injector 1, neither strikes first flange 21, nor second flange 31, but merely strikes the relatively large-surfaced and, therefore, noncritical inner pole 13 of the magnetic circuit. The deformation of the magnetically soft armature casing 34 and subsequent malfunctions, due to imprecise metering, are able to be avoided in this manner. The not magnetically soft armature-stop sleeve 35 does not interfere with the flow of the magnetic field through armature 20.

FIG. 2B, in a part-sectional representation, shows a section through armature casing 34 and armature-stop sleeve 35. In the exemplary embodiment of FIG. 2B, in particular, three beveled surface sections 36 are clearly visible, which assume the guiding of the fuel through armature 20. In this way, separate bores in armature casing 34, which could have a detrimental effect on the stability and symmetry of the magnetically soft armature casing 34, are able to be avoided.

Beveled surface sections 36 may already be implemented during the production of armature-stop sleeve 35. Armature-stop sleeve 35 may advantageously be produced in a cost-effective manner by turning on a lathe or by deep-drawing.

FIG. 2C, in a part-sectional view, shows a cut-out portion of FIG. 1 in the area IIC, or a true-to-scale section through the overall component represented in FIG. 2A.

As can be inferred from FIG. 2C, armature-stop sleeve 35 has a stepped design, so as to ensure the correct assembly of armature jacket 34 and armature-stop sleeve 35.

In addition, FIG. 2C shows a drainage recess 40 of armature-stop sleeve 35 with a bore 41, by which fuel which, due to a pumping effect, collects during the operation of fuel injector 1 in a recess 42 of armature-stop sleeve 35 between it and valve needle 3, is drained into an inner chamber 42 of fuel injector 1, thereby ensuring that damping element 32 remains in its position and is not displaced by the fuel pressure, which may lead to malfunctioning of fuel injector 1.

The present invention is not limited to the exemplary embodiments shown, but may also be applied, for instance, to other designs of armatures 20, such as for flat(-type) armatures and for arbitrary designs of fuel injectors 1. bore 41, by which fuel which, due to a pumping effect, collects during the operation of fuel injector 1 in a recess 42 of armature-stop sleeve 35 between it and valve needle 3, is drained into an inner chamber 42 of fuel injector 1, thereby ensuring that damping element 32 remains in its position and is not displaced by the fuel pressure, which may lead to malfunctioning of fuel injector 1.

The present invention is not limited to the exemplary embodiments shown, but may also be applied, for instance, to other designs of armatures 20, such as for flat(-type) armatures and for arbitrary designs of fuel injectors 1.

What is claimed is:

1. A fuel injector (1) for the direct injection of fuel into the combustion chamber of an internal combustion engine, comprising a valve needle (3), which is in operative connection with a valve-closure member (4), which forms a sealing seat with a valve-seat surface (6); and an armature (20), which is positioned on the valve needle (3) in an axially movable manner und cooperates with a magnetic coil (10), wherein the armature (20) includes an armature casing (34) and an armature-stop sleeve (35), the armature-stop sleeve (35) being inserted into an inner opening (37) of the armature casing (34) in a form-fitting manner.

2. The fuel injector as recited in claim 1,
wherein the armature casing (34) is made of a magnetically soft material.

3. The fuel injector as recited in claim 1 or 2,
wherein the armature-stop sleeve (35) is made of a material that differs from that of the armature casing (34).

4. The fuel injector as recited in claim 3,
wherein the armature-stop sleeve (35) is produced from a hardened metal or a hard metal alloy.

5. The fuel injector as recited in one of claims 1 through 4,
wherein the armature-stop sleeve (35) is pressed into the armature casing (34).

6. The fuel injector as recited in one of claims 1 through 4,
wherein the armature-stop sleeve (35) is welded to the armature casing (34).

7. The fuel injector as recited in one of claims 1 through 6,
wherein the armature-stop sleeve (35) terminates flush with the armature casing (34) at an inflow-side end face (38).

8. The fuel injector as recited in claim 7,
wherein, on the inflow-side end face (38) of the armature-stop sleeve (35), a first flange (21) is supported, which is connected in a force-locking manner to the valve needle (3) via a welding seam (22).

9. The fuel injector as recited in claim 8,
wherein a restoring spring (23) is braced against the side of the first flange (21) that lies opposite the armature-stop sleeve (35).

10. The fuel injector as recited in one of claims 1 through 9,
wherein the armature-stop sleeve (35) abuts against a damping element (32) by a discharge-side end (39).

11. The fuel injector as recited in claim 10,
wherein the damping element (32) is braced against a second flange (31), which is joined in a force-locking manner to the valve needle (3) via a welding seam (33).

12. The fuel injector as recited in one of the claims 1 through 11,
wherein at least one beveled surface section (36) is provided at the armature-stop sleeve (35).

13. The fuel injector as recited in one of claims 1 through 12,
wherein a drainage opening (40) is provided in the armature-stop sleeve (35).

14. The fuel injector as recited in claim 13,
wherein the drainage opening (40) is drained via a bore (41) into an inner chamber (42) of the fuel injector (1).
